(19) United States
(12) Patent Application Publication
(10) Pub. No.: US 2016/0027041 A1
(43) Pub. Date: Jan. 28, 2016

(54) SYSTEM, METHOD AND COMPUTER PROGRAM PRODUCT FOR FRACTIONAL ATTRIBUTION USING ONLINE ADVERTISING INFORMATION

(71) Applicant: Google Inc., Mountain View, CA (US)

(72) Inventors: Shi Zhong, Mountain View, CA (US); Robert Lee Marsa, Mountain View, CA (US)

(21) Appl. No.: 14/878,759

(22) Filed: Oct. 8, 2015

Related U.S. Application Data
(63) Continuation of application No. 13/195,753, filed on Aug. 1, 2011.

(51) Int. Cl. G06Q 30/02; H04L 29/08

(52) U.S. Cl. CPC G06Q 30/0246; H04L 67/22

(57) ABSTRACT

Embodiments disclosed provide technical details on fractional attribution using online advertising information. More specifically, embodiments disclosed herein use historical data to determine one or more conditional probabilities and assign credit weights to given events. In this way, fairer and more accurate attribution of conversions to particular events may be assigned.

### CROSS-REFERENCE TO RELATED PATENT APPLICATIONS

This application claims priority to and is a continuation of U.S. patent application Ser. No. 13/195,753 entitled “System, Method and Computer Program Product for Fractional Attribution Using Online Online Advertising Information,” filed Aug. 1, 2011, incorporated herein by reference in its entirety.

### RESERVATION OF COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to online advertising. More particularly, embodiments disclosed herein relate to a system, method, and computer program product for fractional attribution using display, search, and other advertising information, useful in attributing conversion credits to advertising campaigns.

### BACKGROUND

In a typical online marketing scenario, an operator of a Web site, acting as a publisher, displays ads from advertisers in exchange for some kind of payment. In other scenarios, search engine operators display search results or ads in a particular order in response to advertiser-sponsored search terms. In many cases, advertisers make use of multiple online channels concurrently.

In online marketing, a conversion occurs when exposure to an ad leads directly to behavior considered desirable by an advertiser. For example, if a user clicks on an ad and makes a purchase, this particular click has resulted in a conversion. It is noted that other behaviors can be considered conversions, as well, such as simply clicking on an ad or signing up for additional information.

In any case, an important aspect of online marketing is an attribution model, whereby an advertiser can accurately assess the effectiveness of a particular ad campaign and thus better allocate advertising budget across multiple channels.

The current de facto online marketing attribution model is the so-called “last-click” model. The last-click model gives full credit for a desired outcome (conversion) to the last advertisement event that can be associated with the outcome. While the last-click model is simple and easy to understand, it is often wrong.

For example, suppose a user has seen a display advertisement from advertiser A on one or more Web sites and then employed a search engine to search about A's products, clicked on A's search advertisements, and then converted (e.g., a conversion here could be a visit to A's web site or a purchase of A's products). The last-click model would attribute all the conversion credit to the search engine simply because it was the last event of a series of potentially influential events that led to the ultimate conversion.

According to the last-click model, it would make sense for an advertiser to put all or most of its budget into search engine advertisements. However, it has been found that, if this is done, overall marketing effectiveness actually decreases. Display advertisements are increasingly being seen as brand introducers or purchase assistors higher up in the user purchase funnel. That is, display advertisements might drive users down the purchase funnel and when users get close to the bottom of the funnel and have the intent to purchase an advertiser's products, it is very likely that they would go through the search channel and convert via the search advertisements. If there is no display advertisement, then, the upstream source of users with intent to purchase a given product dries up and the effectiveness of search advertisement actually drops in the long run.

From advertisers' and hosts' perspectives, it would be desirable to move away from the last-click model to a more reasonable fractional attribution model that more correctly give credits to display advertisements and perhaps other advertising channels (such as email and affiliate, or even offline) for all desired outcomes received. It would also help the advertiser make the right decisions as to how to better allocate advertising budget across different channels.

### SUMMARY

Embodiments disclosed herein provide a system, method, and computer program product for fractional attribution using display, search, and other advertising information. In some embodiments, an attribution platform may have input data from one or more client computers and servers coupled to the platform. Input data may include one or more log files and/or impression and click data. An end user may be exposed to one or more advertising channels, e.g., he may receive directed e-mail advertisements, or may visit one or more Web sites or search engines having advertisements hosted by a client of the attribution platform. The end user may use a Web browser application running on a user device and may click on or otherwise convert (e.g., visit the advertiser's Web page, sign up for additional mailings, or make a purchase) upon exposure to one or more of the advertising channels.

In some embodiments, an attribution method employs historical data to determine one or more conditional probabilities. In particular, in some embodiments, an attribution model may comprise determining a first conditional probability of exposure to an advertising event given an occurrence of other advertising events and an ultimate conversion. The method may further comprise determining a second conditional probability of an advertising event given the occurrence of other advertising events. In some embodiments, the credit weight given to that event is determined as a function of the first and second conditional probabilities. In some embodiments, the credit weight is inversely proportional to the second conditional probability.

In some embodiments, an attribution model may comprise determining a number of converted users exposed to all but one event in a set of advertising events. The method may further comprise determining the number of all users exposed to all but that one event in the set of advertising events. In some embodiments, the credit weight given to that one event is determined as a function of the number of users and number of converted users. In some embodiments, the credit weight given to a particular event is proportional to the probability of conversion given exposure to a set of events not including the particular event.

In some embodiments, the attribution method defines events across granularity levels, determines attribution weights for those events, and combines them based on confidence levels of the different estimates. For example, in some embodiments, a less granular level is a “campaign” event, while higher granularities include a “campaign and frequency” event and a “campaign and recency” event. The resulting attribution weight at a given level of granularity is then a function of a confidence-weighted average across different levels.

In some embodiments, the attribution model may comprise creating an event definition, i.e., a particular granularity level. For each event definition, the method may further comprise creating event sets for each user/conversion, that is arranging events by user and conversion so as to list all the events the user was exposed to prior to conversion. The method may further comprise, for each event definition, defining subsets, i.e., sets of K−1 events for each set of K events. The method may further comprise, for each event subset, determining the number of converting users and non-converting users and determining attribution weights based on a function of the two. The method may further comprise, for each event definition, populating the attribution weights down to the most granular level. The method may further comprise combining the attribution weights from the different event definitions or granularity levels using, for example, a confidence-weighted average across the granularity levels.

In some embodiments, the attribution method may be embodied in a computer program product comprising at least one non-transitory computer readable medium storing instructions translatable by at least one processor to perform the method. In some embodiments, an attribution system may comprise software and hardware, including the at least one non-transitory computer readable medium, necessary to implement the attribution method.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include random access memories, read-only memories, hard drives, datacartridges, magnetic tapes, floppy diskettes, flash memory drives, optical data storage devices, compact-disc read-only memories, and other appropriate computer memories and data storage devices.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example user transaction in a network environment where embodiments disclosed herein may reside;

FIG. 2 depicts a diagrammatic representation of an example system architecture comprising multiple clients coupled to an attribution platform, implementing some embodiments disclosed herein;

FIG. 3 depicts an exemplary event tree according to some embodiments disclosed herein;

FIG. 4 is a flowchart illustrating attribution modeling according to some embodiments disclosed herein;

FIG. 5 is a table illustrating comparative results for fractional attribution and last event attribution according to some embodiments disclosed herein;

FIG. 6 is a plot diagram illustrating comparative differences by campaign for fractional attribution and other attribution methods according to some embodiments disclosed herein; and

FIG. 7 is a table illustrating cost per conversions based on attribution results.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Thus, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Various substitutions, modifications, additions and/or rearrangements within the spirit and/or scope of the underlying inventive concept will become apparent to those skilled in the art from this disclosure.

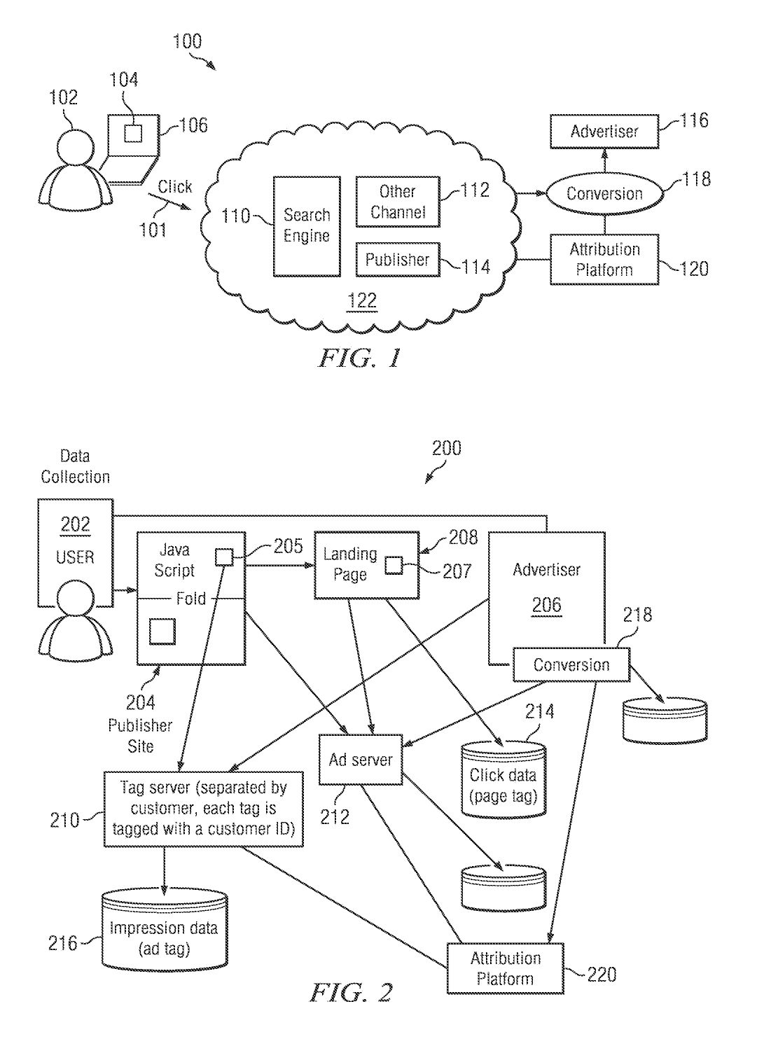

FIG. 1 depicts a diagrammatic representation of an example network environment for fractional cross-channel attribution.

In the example of FIG. 1, a user 102 may “convert,” or perform a desired action, after clicking a link 104 (e.g., a banner ad on a publisher web site 114, a search engine ad 110, or an ad on another channel 112), via a user device 106 at a particular Internet Protocol (IP) address and being directed via network 122 to the advertiser's web page 116. Conversion 118 can be a purchase transaction, but could also include such actions as registering with a Web site, signing up for product information, and the like.

An attribution platform 120 in accordance with embodiments of the invention allows the advertiser 116 to make informed decisions about payment for advertisements and future ad campaigns.

Data from the click 101 and ultimate conversion 118 may be collected in a variety of ways. In some embodiments, one or more computers in the network 122 may collect click data. In some embodiments, a click data collecting computer may be a server machine residing in a publisher 114's or other party's computing environment or network. In some embodiments, the click data collecting computer may collect click streams associated with visitors to one or more Web sites. In some embodiments, the collected information may be stored in one or more log files. In some embodiments, the information associated with the plurality of clicks may comprise visitor Internet Protocol (IP) address information, date and time information, publisher information, referrer information, user-agent information, searched keywords, cookies, and so on. For additional examples on collecting information provided from a visitor's Web browser application, readers are directed to U.S. patent application Ser. No. 11/796,031, filed Apr. 26, 2007, entitled “METHOD FOR COLLECTING ONLINE VISIT ACTIVITY,” which is fully incorporated herein by reference.

In some embodiments, the attribution platform 120 employs “ad tags” for monitoring impression data and “page tags” for monitoring click data. Ad tags can be 1×1 pixels embedded in page code at the publisher site and can be used to determine where the ad is on a page (above or below a “fold,” i.e., visible with or without scrolling) and whether and how long a user sees it. Page tags can be embedded in a similar manner on the landing page, and can identify whether a user has arrived and where the user comes from. Example tags are included in the attached Appendices A and B. As will be described in greater detail below, ad tags or page tags can be transmitted to the attribution platform 120 responsive to a user viewing or clicking on an ad and viewing or clicking on an associated web page.

FIG. 2 depicts a diagrammatic representation of example system architecture 200 comprising one or more clients 202 and attribution platform 220. A user may browse a publisher site 204 which maintains one or more ad tags 205. Ad tag data can be sent to a tag server 210, responsive to a user viewing or clicking an ad, which stores in a database 216, impression data sorted by customer. Such data may include, e.g., where, when, and how long a user viewed the ad.

An ad server 212 may be used to maintain the ad on the publisher's web site 204. The user 202 may click an ad to arrive at a landing page 208. Embedded on the landing page 208 includes a page tag 207, which identifies user accesses to the landing page 208 and may be sent to a database 214 accessible by the attribution platform 220. An advertiser 206 records a conversion 218, if any, and likewise provides the information to the attribution platform 220.

Attribution platform 220 may reside in a computing environment comprising one or more server machines. Each server machine may include a central processing unit (CPU), read-only memory (ROM), random access memory (RAM), hard drive (HD) or non-volatile memory, and input/output (I/O) device(s). An I/O device may be a keyboard, monitor, printer, electronic pointing device (e.g., mouse, trackball, etc.), or the like. The hardware configuration of this server machine can be representative of other devices and computers alike at a server site (represented by platform 220) as well as at a client site.

Embodiments of platform 220 disclosed herein may include a system and a computer program product implementing a method for fractional attribution in a network environment. In some embodiments, platform 220 may be owned and operated independent of the clients that it services. For example, company A operating platform 220 may provide attribution services to company B operating a client (not shown). In one embodiment, Companies A and B may communicate over a network. In one embodiment, Companies A and B may communicate over a secure channel in a public network such as the Internet. Example clients may include advertisers, publishers, and ad networks.

In some embodiments, the system may run on a Web server. In some embodiments, the computer program product may comprise one or more non-transitory computer readable storage media storing computer instructions translatable by multiple processors to process attribution data. The input data may be from a log file, a memory, a streaming source, or ad and page tags. Within this disclosure, the term “attribution data” refers to any and all data associated with online advertising events such as clicking on an ad, viewing an ad (an impression), entering a search query, conversion, and so on, and may include click history data, click intelligence data, post-click data, visitor profile data, impression data, etc.

In some embodiments, software running on a server computer in platform 220 may receive a client file containing attribution data from an attribution data collecting computer associated with a client. For example, a client may represent an online retailer and may collect click stream data from visitors to a Web site own and/or operated by the online retailer. The attribution data thus collected can provide a detailed look at how each visitor got to the Web site, what pages were viewed by the visitor, what products and/or services the visitor clicked on, the date and time of each visit and click, and so on. The specific attribution data that can be collected from each click stream may include a variety of entities such as the Internet Protocol (IP) address associated with a visitor (which can be a human or a bot), timestamps indicating the date and time at which each request is made or click is generated, target URL or page and network address of a server associated therewith, user-agent (which shows what browser the visitor was using), query strings (which may include keywords searched by the visitor), and cookie data. For example, if the visitor found the Web site through a search engine, the corresponding click stream may contain the referrer page of the search engine and the search words entered by the visitor. Attribution data can be created using a corporate information infrastructure that supports a Web-based enterprise computing environment. A skilled artisan can appreciate what typical attribution click streams may contain and how they are generated and stored.

Thus, in some embodiments, optimization data may include an impression/click record for every ad impression/click received from a given client of the system. An example impression/click record may include at least the following attributes:
Impression/click timestamp;
visitor cookie (if available, may be set up as a domain cookie for persistent visitor identification);
visitor IP address;
visitor browser user-agent;
impression/click source (may be a publisher ID or a referrer domain);
click destination (landing page Web address or bid keywords for advertisers); and
conversion data (whether the visitor executed a desired conversion).

For the sake of simplicity, hardware components (e.g., CPU, ROM, RAM, HD, I/O, etc.) are not illustrated in FIG. 2. Embodiments disclosed herein may be implemented in suitable software code (i.e., computer instructions translatable by a processor). As one skilled in the art can appreciate, computer instructions and data implementing embodiments disclosed herein may be carried out on various types of computer-readable storage media, including volatile and non-volatile computer memories and storage devices. Examples of computer-readable storage media may include ROM, RAM, HD, direct access storage device arrays, magnetic tapes, floppy diskettes, optical storage devices, etc. As those skilled in the art can appreciate, the computer instructions may be written in any suitable computer language, including C++. In embodiments disclosed herein, some or all of the software components may reside on a single server computer or on any combination of separate server computers. Communications between any of the computers described above may be accomplished in various ways, including wired and wireless. As one skilled in the art can appreciate, network communications can include electronic signals, optical signals, radio-frequency signals, and other signals as well as combinations thereof.

Without loss of generality, assume that a user has had three events (i.e., three interactions with a marketer's various campaigns; the definition of interactions is discussed below), prior to her conversion. The fractional attribution problem includes figuring out what fraction of the conversion credit goes each of the three events. A more mathematical description can be as follows:

If a user had events E₁, E₂, and E₃ and then converted, what fractional credit w₁ goes to E₁, w₂ goes to E₂, and w₃ goes to E₃, subject to Σⱼ₌₁³wⱼ=1?

In this example, it is assumed that the conversion event is 100% driven by the combination of the three events {E₁,E₂,E₃}. In reality this might not be true. However, it appears likely that whatever factors not observed introduce the same bias to all the campaigns in the data. The fractional attribution results are still useful in reflecting the relative importance of different channels/campaigns or of any other entities in which one might be interested.

In some embodiments, a good attribution model may possess three desirable properties: Monotonicity (Property 1); Correlation with Conversion (Property 2); and Accounting for Event Interactions (Property 3).

The first desired property is Monotonicity, which means that if two events (e.g., E₁ and E₂) were combined into one composite event E₁₂ then the fraction credit w₁₂ for E₁₂ should most likely be no less than w₁, or w₂. That is, w₁₂≧w₁ and w₁₂≧w₂. The intuition is that two events a converted user has with a marketer's campaigns should deserve no less credit than each of those two events individually.

The second property, Correlation with Conversion, holds that the weight for each event should be roughly correlated with the event's ability to drive conversions based on historical data. If E₁. historically has driven conversions better than E₂ and E₃ together, then E₁ deserves more credit than either E₂ and E₃.

The third property of the model should take into account as much as possible the interactions among different events. For example, if individually each of the three events has driven conversions equally well, but when, E₂ and E₃ are together they have driven conversions much better, a higher credit weight should be given to either E₂ or E₃ than to E₁.

Let conversion be represented by C, in mathematical terms, this means
If P(C|E₁)≅P(C|E₂)≅P(C|E₃) but (C|E₂, E₃)>>P(C|E₁), then we probably should have w₂>>w₁ and w₃>>w₁.

Embodiments of the invention make use of data-driven probabilistic models. That is, all the conditional probability estimates discussed herein are based on historical data.

In particular, each conditional probability P(A|B) can be derived from historical data by dividing the number of users who (at least) had events A and B by number of users who (at least) had event B. That is,

$$P ( A \vert B ) = \frac{\# users with events A and B}{\# users with event B}$$

Embodiments of the invention may make use of any of a variety of models, although some may be more or less desirable, depending on the nature of the data.

A first model (Model 1) may be the Naive Bayes model:
Consider the naive Bayes model for P(C|E₁, E₂, E₃:

P(C|E₁,E₂,E₃)∝P(C|E₁)·P(C|E₂)·P(C|E₃).
One natural idea would be to use

wⱼ=P(C|Eⱼ),j=1, 2, 3

This naive choice does possess Properties 1 & 2 discussed above. However, this model assumes that the three events {E₁,E₂,E₃} are independent given the conversion event C. It does not return the right answer when there are strong event correlations; that is, it does not possess Property 3. For example, in the example used for explaining Property 3, this model would NOT give a higher weight to either E₂ or E₃ than that to E₁, which is desired.

A second model (Model 2) may be the Conversion Index model:
If w₁ is set to be the conversion index of E₁

$${w}_{1} = \frac{P ( C \vert {E}_{1} )}{P ( C \vert {\overline{E}}_{1} )} ∝ \frac{( 1 - P ( {E}_{1} ) ) \cdot P ( C \vert {E}_{1} )}{P ( C ) - P ( {E}_{1} ) \cdot P ( C \vert {E}_{1} )}$$

where Ē₁ means “no event E₁”. This model turns out to be very similar to the naive Bayes model because w₁ in (3) is strongly positively (although nonlinearly) correlated with P(C|E₁). As in the naive Bayes model, correlations among the three events are not taken into account.

A third model (Model 3) may be the Conditional Importance model:
Consider capturing the importance E₁ by the conditional probability

$${w}_{1} = P ( {E}_{1} \vert {E}_{2} , {E}_{3} , C ) = \frac{P ( {E}_{1} , {E}_{2} , {E}_{3} , C )}{P ( {E}_{2} , {E}_{3} , C )} ∝ \frac{1}{P ( {E}_{2} , {E}_{3} , C )} ∝ \frac{1}{\# users with \{ {E}_{2} , {E}_{3} , C \}} \qquad ( 4 )$$

which indicates how likely E₁ is observed given that we observe {E₂,E₃,C}. However, with (4), w₁ may change in the wrong direction when the specificity of E₁ is increased. For example, if (4) were used to compute the importance of a composite event E₁₂={E₁, E₂}, the result would be

$${w}_{12} ∝ \frac{1}{\# users with \{ {E}_{3} , C \}}$$

which will most likely be smaller than w1, even though according to Property 1 one would normally expect the opposite (w₁₂>w₁), i.e., the composite event E₁₂ should most likely get more conversion credit, not less.

A fourth model (Model 4) may be the Marginal Importance model:
Consider an improvement of Model 3 as follows

$${w}_{1} = \frac{P ( {E}_{1} \vert {E}_{2} , {E}_{3} , C )}{P ( {E}_{1} \vert {E}_{2} , {E}_{3} )} = \frac{P ( C \vert {E}_{1} , {E}_{2} , {E}_{3} )}{P ( C \vert {E}_{2} , {E}_{3} )} ∝ \frac{1}{P ( C \vert {E}_{2} , {E}_{3} )} \qquad ( 5 )$$

This normalizes the probability of seeing E₁ given {E₂,E₃,C} in (4) by the probability of seeing E₁ given {E₂,E₃}. The idea is that, if E₁ is equally likely with or without C (given {E₂,E₃}, then it is probably not that important.
Also what it means is that if E₂&E₃ together drive conversions as well as all three events together, i.e., P(C|E₂, E₃) is close to P(C|E₁, E₂, E₃), then E₁ is probably not that important and the weight for E₁ should be small.

This new importance measure does not have the issue of Model 3 as the composite event E₁₂={E₁,E₂} would have an importance weight most likely higher than w₁, or w₂ alone. It can be imagined that

$${w}_{12} ∝ \frac{1}{P ( C \vert {E}_{3} )}$$

is most likely higher than w₁ as it is most likely that P(C|E₂)<P(C|E₂, E₃). Again the intuition here is that normally for a given user, the more he is advertised to, the more likely he is to convert.

This model also addresses the issue of not considering event interactions (as mentioned for Model 1&2). Suppose E₁ & E₂ together is effective and drives a high P {FORMULA} but it is not the case for P)C|E₁, E₃) and P(C|E₂, E₃), it can be seen that based on (5) E₁ &E₂ will each get more credits than E₃.

A variant of Model 4 can be

$${w}_{1} = \frac{P ( {E}_{1} \vert {E}_{2} , {E}_{3} , C )}{P ( {E}_{1} \vert {E}_{2} , {E}_{3} , \overline{C}} ∝ \frac{1 - P ( C \vert {E}_{2} , {E}_{3} )}{P ( C \vert {E}_{2} , {E}_{3} )} \qquad ( 6 )$$

This weight becomes zero when P(C|E₂, E₃)=1.

Overall, the Marginal Importance model in (5) seems to provide better results than the other models discussed and possesses the three desired properties proposed above.

To generalize to the situation in which there are there are more than three events, say a converted user had K events, {E₁,E₂, . . . ,Eₖ}, the credit weight for Eⱼ(j=1, . . . , K) would be

$${w}_{j} ∝ \frac{1}{P ( C \vert \{ {E}_{1} , {E}_{2} , … , {E}_{K} \} \backslash {E}_{j}} ∝ \frac{\# all users with \{ {E}_{1} , {E}_{2} , … , {E}_{K} \} \backslash {E}_{j}}{\# converted useres with \{ {E}_{1} , {E}_{2} , … , {E}_{K} \} \backslash {E}_{j}} ,$$

where {E₁,E₂, . . . ,E_{K}} \Eⱼ means the subset of {E₁,E₂, . . . ,E_{K}} without Eⱼ

The definition of events may vary from implementation to implementation. For example, E₁ could represent a user seeing one or more impressions from a specific campaign; or a user seeing one or more impressions from a specific campaign more than two weeks ago; or a user seeing exactly two impressions from a specific campaign in the last day; or a user seeing one or more impressions on a specific site in the last day; etc.

As can be appreciated, the list of possible definitions can quickly become intractable. The question is which definitions make more sense than others for a particular implementation and how to combine attribution results if one were to run attribution analysis with different event definitions.

It may be desirable to define an event as specifically as possible; e.g., a user seeing exactly n impressions from campaign x with creative y on site z exactly m days ago. However, defining events at that deep level of granularity may encounter data sparsity—often there is not enough data to robustly derive the conditional probabilities described in the previous section. It may sound counterintuitive as the system easily collects billions of impressions and hundreds of millions of users every month from a large advertiser. However, not many users would share the same event of “seeing exactly n impressions from campaign x with creative y on site z exactly m days ago”. When the number of users is small, there would be low confidence in the conditional probabilities estimated.

To increase confidence levels, one can define events at a less granular level such as the campaign level. There are likely a lot of (both converted and non-converting) users sharing the event of “seeing at least one impression from campaign x”, making the estimates at campaign level more robust. However, if there are only estimates at the campaign level, it does not help to attribute conversion credits across different sites, different frequency or recency values for the same campaign.

In some embodiments, an attribution analysis may be run at many different granularity levels and then combined based on confidence values of different estimates. One technique for this task is “hierarchical Bayesian shrinkage.” The goal is to get as robust as possible an estimate at the most granular level. One way to address data sparsity at the granular level is to borrow information (or estimates) from lower granularity levels.

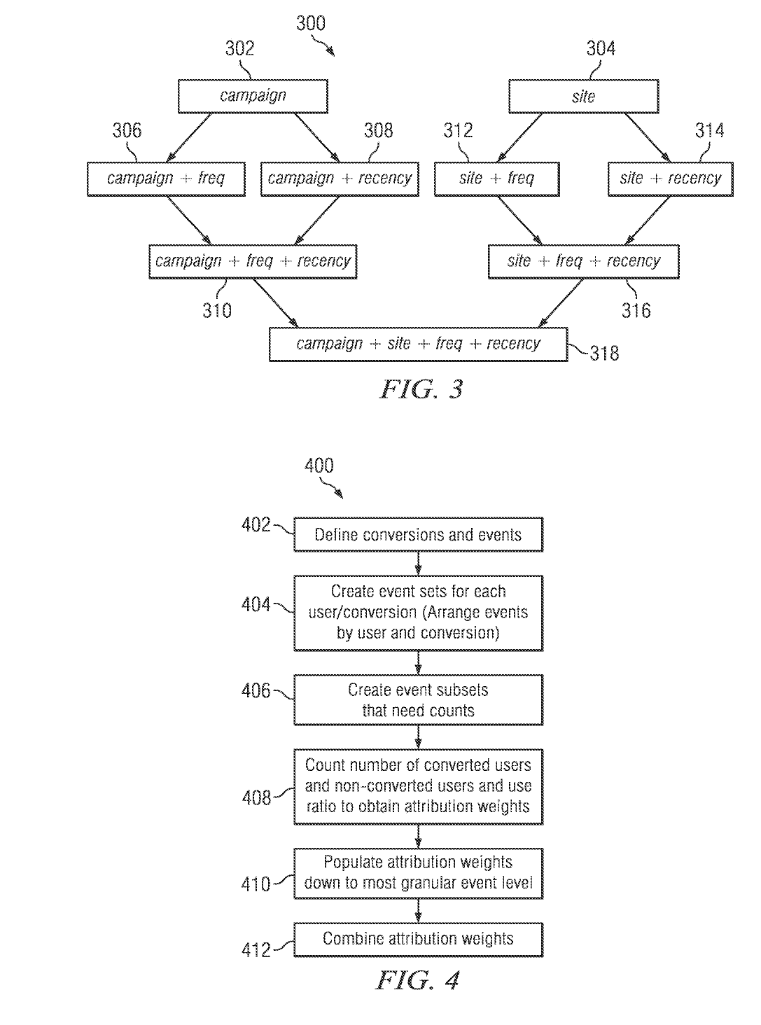

In some embodiments, different levels can be arranged into a hierarchy 300 like the one shown in FIG. 3. In particular, shown are parent nodes campaign 302 and site 304. Campaign node 302 is less granular and a parent to the nodes at the next most granular level, campaign+frequency 306 and campaign+recency 308. The nodes 306, 308 in turn are parents to node 310 (campaign+frequency+recency).

Likewise, parent node site 304 is parent to site+frequency 312 and site+frequency node 314 which, in turn, are parents to site+frequency+recency node 316. Nodes 310 and 316 are parents and less granular than node 318 (campaign+site+frequency+recency).

The attribution weight for a given event can be calculated for every node in the hierarchy and combined based on the confidence of each calculation. Confidence can be a function of the amount of data (i.e., the number of users) used to estimate the conditional probabilities. For example, a reasonable confidence function is the sigmoid function

$$ℊ ( n ) = \frac{1}{1 + {e}^{- ( \frac{n - μ}{a} )}} ,$$

where n is the number of users, and μ and α are adjustable parameters. The parameter μ determines when confidence becomes 0.5 and α controls how fast the confidence grows with n.

One way of combining the attribution weights estimated at different granularity levels is to take a confidence-weighted average across different levels. That is,

Σ₁g₁w₁/Σ₁g₁,

where w₁ is the attribution weight at level l and g₁ is the confidence at level l. This effectively shrinks the (less robust) estimate at the most granular level towards (more robust) estimates at less granular levels, thus the name of “shrinkage”. In statistical terms, it is a tradeoff between bias and variance. At more granular levels, the estimates have lower bias but higher variance; at less granular levels, the estimates have lower variance (i.e., more robust) but higher bias. It will be appreciated that the actual equation may vary somewhat from implementation to implementation. For example, one embodiment may add a level-dependent weight that is fixed for each level to reflect prior knowledge about the importance of difference levels. That is, if enough data can be had at a campaign+recency level, one might want to give more weight to that level than to a less granular (e.g., campaign) level.

FIG. 4 is a flowchart illustrating operation of embodiments of the invention for generating fractional attribution results.

In a step 402, conversions and events are defined. As noted above, in some embodiments, a conversion is a desired activity, such as a user purchase of an advertiser's product or service. An event can be one or more user-defined events or sequences of events.

In a step 404, for each event definition (i.e., a particular granularity level), event sets for each user/conversion are created. This is essentially to arrange events by user and conversion. For each incidence of the conversion, this step may include listing all the event item exposures the user had prior to the conversion. Events are defined and tracked from the raw impression/click/conversion data obtained from the ad tags and page tags or log files or other data collected.

In a step 406, for each event definition, create event subsets that need counts. That is, for each event set of size K (that associates with a conversion), generate K−1 event subsets as explained above.

In a step 408, for each event definition, and for each event subset generated, count the number of converted users and number of non-converting users and use the ratio between those two as the basis for computing attribution weights. The total user counts may also be used as the basis for computing confidence as described above.

In a step 410, for each event definition, populate the attribution weights down to the most granular event level, i.e., individual impressions or clicks. Depending on the event definition, each event may map to one or more impressions/clicks and the attribution weight computed for the event will be evenly distributed down to individual impressions/clicks. For example, if events are defined by a campaign+recency, an event (campaign x+3 days ago) gets a weight of 0.6 and it corresponds to 10 impressions on that day, then each of those 10 impressions would get a weight of 0.06.

Finally, in a step 410, combine the attribution weights from different event definitions (i.e., different granularity levels) using, for example, the hierarchical Bayesian shrinkage method described above.

In some embodiments, step 406—getting the user counts for each event subset—is computationally intensive. There can be hundreds of millions of users and hundreds of thousands of subsets. Each user is represented by an event set (all the events the user has had). The basic operation is, for each user and each subset, to determine if the user's event set contains the subset of interest (for which we want to get user counts).

One efficient way of doing the counting is to determine, for each user, which n events he has seen, and to define (n−1) subsets. For example, if he has seen events E1, E2, E3, then the subsets are defined as follows:

S1 E1, E2

S2 E1, E3

S3 E2, E3

For each event in any of the subsets, keep track of the list of the indexes of the subsets that contain the item.

Then, for each user, go through each event in the user's event set and add all the subset indexes to a hash and keep track of the counts. For example, for event E1, add the subset indexes of S1 and S2 to a hash; for event E2, add the subset indexes of S1 and S3 to a hash; and for event E3, add the subset indexes of S2 and S3 to a hash. If the hash count of a subset index equals the length of the subset, increase the user count for a subset.

These steps can be performed for both converted users and non-converting users, separately, to obtain the counts. Further, these steps can be easily parallelized in practice.

An additional simplification may be made by noticing that most of the users are non-converting users. As such, a sample of the non-converting users may be taken to reduce the computation. Experiments have shown that using a 10% sample of non-converting users seems to generate roughly the same attribution weights vs. using all users' data.

The process of shortcut counting of converting and nonconverting users is shown below by way of an eight event example:

Shown in Table 1 below are exemplary event data (Each row in this example is a user event sequence; E₁-E₈ are eight events to be assigned conversion credits; C/NC stands for conversion/no conversion):

TABLE 1

| | |
|---|---|
| E₁ E₂ E₃ | C |
| E₁ E₂ E₅ | NC |
| E₃ E₄ E₅ | C |
| E₁ E₃ E₄ E₅ | NC |
| E₁ E₂ E₆ | C |
| E₃ E₄ E₅ E₆ | C |
| E₁ E₅ E₆ E₇ | C |
| E₁ E₂ E₄ E₆ E₇ | NC |
| E₂ E₃ E₄ E₇ | NC |
| E₁ E₂ E₃ E₅ E₇ | NC |
| E₁ E₃ E₅ E₆ E₈ | NC |
| E₂ E₆ | NC |

For each converted user, generate all leave-one-out subsequences. For example, from the first converted user, one gets {E₁, E₂}, {E₂, E₃}, and {E₁ E₃}.

Next, merge the sub-sequences from all converted users. For example, from the four converted users, one gets the following 12 sub-sequences, where the second column is an index assigned to the sub-sequences:

TABLE 2

{E₁, E₂}, 1
{E₂, E₃}, 2
{E₁, E₃}, 3
{E₃, E₄}, 4
{E₄, E₅}, 5
{E₃, E₅}, 6
{E₁, E₆}, 7
{E₂, E₆}, 8
{E₁, E₅, E₆}, 9
{E₁, E₅, E₇}, 10
{E₁, E₆, E₇}, 11
{E₅, E₆, E₇}, 12

For each sub-sequence S, count the number of converted users (n_{conv}) and number of non-converting users (n_{nonconv}) that have the sub-sequence and compute the conditional probability

$$P ( C \vert S ) = \frac{{n}_{conv} + 1}{{n}_{conv} + {n}_{nonconv} + 2}$$

(the extra count 1 and 2 added to the numerator and denominator are priors used to smooth out estimate from very sparse data)

To get the counts (n_{conv} and n_{nonconv}), do the following:
For each event, build an inverted index for each event that appeared in any converted user sequence, which stores the indexes of the sub-sequences that contain the event.

TABLE 3

| | |
|---|---|
| E₁ | {1, 3, 7, 9, 10, 11} |
| E₂ | {1, 2, 8} |
| E₃ | {2, 3, 4, 6} |
| E₄ | {4, 5} |
| E₅ | {5, 6, 9, 10, 12} |
| E₆ | {7, 8, 9, 11, 12} |
| E₇ | {10, 11, 12} |

For each user sequence in Table 1, use the inverted index to determine which sub-sequences in Table 2 are subsets of the user sequence, i.e., for which sub-sequences one should increment n_{conv} and/or n_{nonconv}. That is, for the first converted user sequence {E₁E₂E₃→C},
generate the following list from the inverted index Table 3: {1,3,7,9,10,11; 1,2,8; 2,3,4,6} and then the sub-sequence counts (number of times appearing in the list)

TABLE 4

```
  1:2 ✓
  2:2 ✓
  3:2 ✓
  4:1 x
  6:1 x
  7:1 x
  8:1 x
  9:1 x
10:1 x
11:1 x
```

where the last column indicates whether each sub-sequence is a subset of the user sequence (by comparing the counts in the second column to the length of the sub-sequence; e.g., sequence 1 has a count of 2 in Table 4 and a length of 2 as seen in Table 2). Therefore, by going through, the user sequence {E₁E₂E₃→C}, it was determined that one should increase n_{conv} for sub-sequence 1, 2, and 3.

Results from operation of attribution modeling according to some embodiments will be discussed by way of example below.

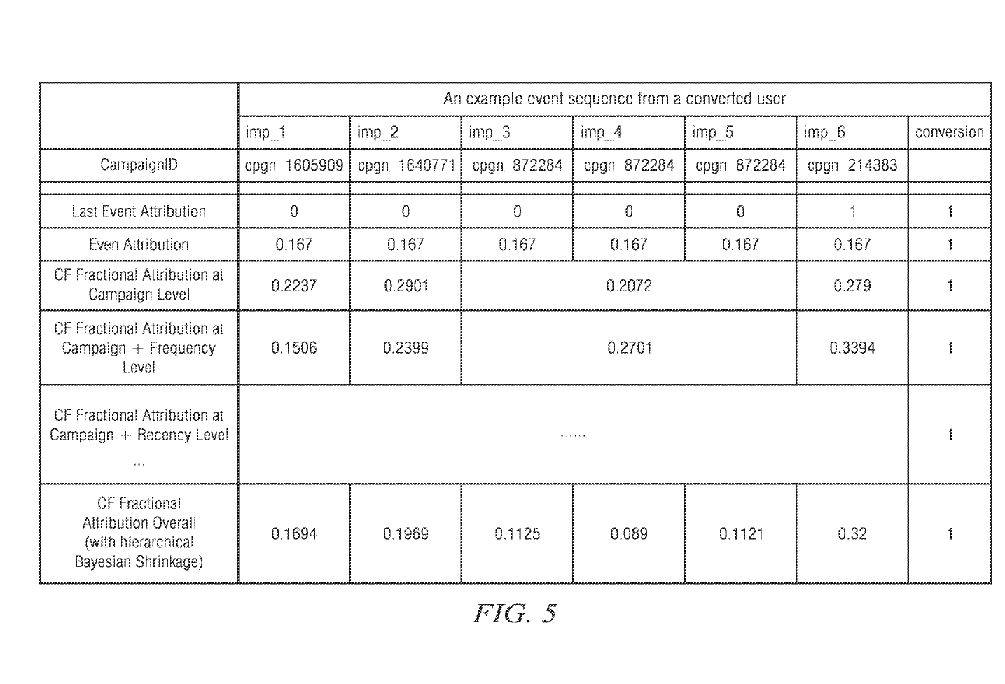

FIG. 5 shows attribution weights for a particular user with six impression events before a conversion. The six impressions (imp_1, imp_2, . . . imp_6) are arranged in temporal order. The last-click model assigns all credit to imp_6 whereas an even attribution model assign ⅙ credit to each of the six events. The next two rows show the results of fractional attribution model at campaign level and campaign+frequency level, respectively. In this case, there are four event items for both of those levels but the weights are different as one takes into account frequency in the event definition and the other does not.

For simplicity, results for many other levels are omitted and in the last row the final fractional attribution results based on applying hierarchical Bayesian shrinkage to combine the results from all different levels are shown.

After this is done for every conversion, the result is a weight for each impression/click event (i.e., at the most granular level). These final weights can then be rolled up along different dimensions for reporting. Common dimensions of interest include campaign, site, creative, etc.

FIG. 6 compares the fractional model with the last-click model and even attribution model, after rolling up the attribution weights to campaign level. Campaign IDs are shown on the x-axis and relative difference between models on the y-axis. For example, for campaign ID 214383 (highlighted in the box), the fractional attribution model assigns to it 12% less credit than last-click model does, but 20% more than even model does.

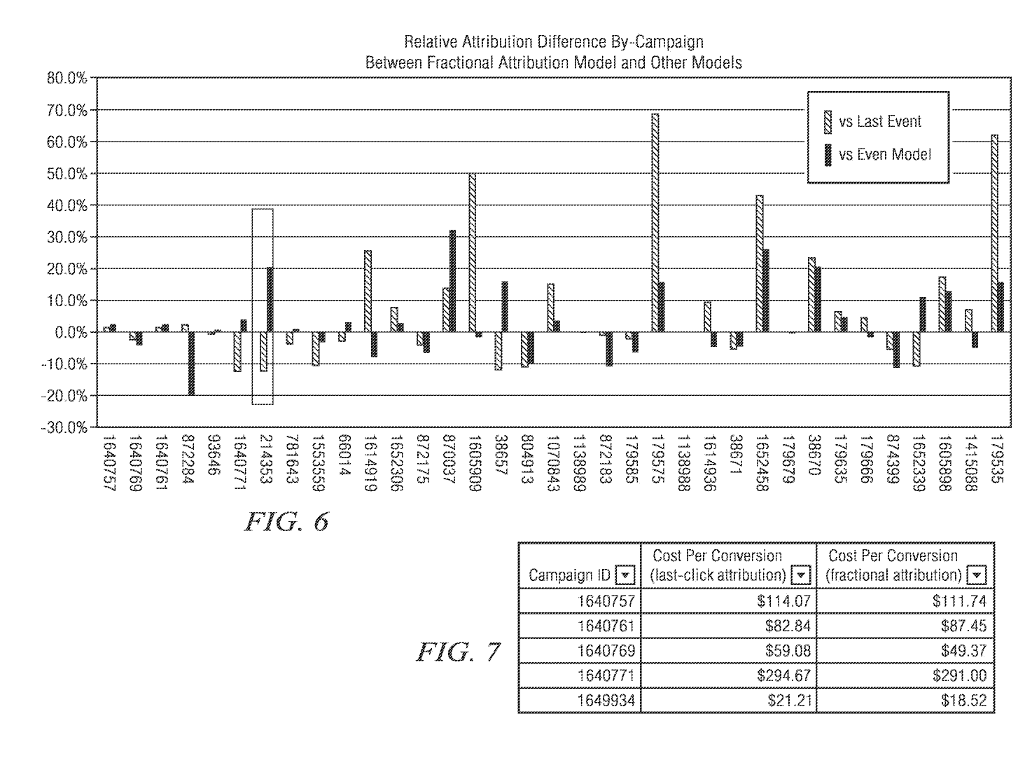

FIG. 7 shows some examples of the cost per conversion metrics based on attribution results. In accordance with embodiments of the invention, the cost numbers based on fractional attribution models will be more accurate and can help make better business decisions regarding whether to increase or decrease spend on a particular campaign.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

Furthermore, the term “or” as used herein is generally intended to mean “and/or” unless otherwise indicated. As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

Although the foregoing specification describes specific embodiments, numerous changes in the details of the embodiments disclosed herein and additional embodiments will be apparent to, and may be made by, persons of ordinary skill in the art having reference to this description. In this context, the specification and figures are to be regarded in an illustrative rather than a restrictive sense, and all such modifications are intended to be included within the scope of this disclosure. Accordingly, the scope of the present disclosure should be determined by the following claims and their legal equivalents.

What is claimed is:

1. A method comprising:
receiving, by one or more processors, attribution data from a plurality of client devices responsive to ad tags executing on each of the plurality of client devices, the attribution data of each of the plurality of client devices associated with a plurality of event items;
receiving, by one or more processors, a plurality of defined events and a defined conversion, the plurality of defined events defined across a plurality of granularity levels;
determining, by one or more processors, a plurality of subsets of events for a sequence of event items based on the plurality of defined events, the defined conversion, and the attribution data of the plurality of client devices, each of the plurality of subsets of events corresponding to a respective set of event items of the sequence of event items that exclude one of the event items of the sequence of event items;
determining, by one or more processors, a number of conversions and a number of remaining event items for each of the plurality of subsets of event items;
determining, by one or more processors, an attribution weight for each of the plurality of defined events defined across the plurality of granularity levels based, at least in part, on a ratio of the determined number of conversions to the determined number of remaining event items for each of the plurality of subset of event items;
determining, by one or more processors, a credit weight for each of the plurality of defined events based on the attribution weights.

2. The method of claim 1, wherein the determined credit weight for each of the plurality of defined events is a function of a confidence-weighted average across the plurality of granularity levels.

3. The method of claim 1, further comprising:
determining a first number of sequences of event items that converted and that included a set of defined events excluding the defined event of the plurality of defined events as event items of the respective sequence of event items; and
determining a second number of sequences of event items that included a set of defined events excluding the defined event of the plurality of defined events as event items of the respective sequence of event items.

4. The method of claim 1, wherein the determined credit weight for a defined event of the plurality of defined events is proportional to a probability of conversion for a set of defined events of the plurality of defined events that exclude the defined event.

5. The method of claim 1, wherein the determined credit weight for a defined event of the plurality of defined events is proportional to a function of:
a first number of sequences of event items that converted and that included a set of defined events excluding the defined event of the plurality of defined events as event items of the respective sequence of event items; and
a second number of sequences of event items that included a set of defined events excluding the defined event of the plurality of defined events as event items of the respective sequence of event items.

6. The method of claim 1, wherein the plurality of granularity levels form a hierarchy.

7. The method of claim 6, wherein the determined credit weight for each of the plurality of defined events is based on the attribution weights for each of the plurality of defined events defined across the plurality of granularity levels and confidence values for each of the plurality of granularity levels.

8. A computer readable storage device storing instructions that, when executed by one or more processors, cause the one or more processors to perform operations comprising:
receiving attribution data from a plurality of client devices responsive to ad tags executing on each of the plurality of client devices;
defining a plurality of events and a conversion, the plurality of defined events defined across a plurality of granularity levels;
determining a plurality of subsets of events for a sequence of event items based on the plurality of defined events, the defined conversion, and the attribution data, each of the plurality of subsets of events corresponding to a respective set of event items of the sequence of event items that exclude one of the event items of the sequence of event items;
determining a number of conversions and a number of remaining event items for each of the plurality of subsets of event items;
determining an attribution weight for each of the plurality of defined events defined across the plurality of granularity levels based, at least in part, on a ratio of the determined number of conversions to the determined number of remaining event items for each of the plurality of subset of event items; and
determining a credit weight for each of the plurality of defined events based on the attribution weights.

9. The computer readable storage device of claim 8, wherein the determined credit weight for each of the plurality of defined events is a function of a confidence-weighted average across the plurality of granularity levels.

10. The computer readable storage device of claim 8 storing instructions that, when executed by one or more processors, cause the one or more processors to perform operations further comprising:
determining a first number of sequences of event items that converted and that included a set of defined events excluding the defined event of the plurality of defined events as event items of the respective sequence of event items; and
determining a second number of sequences of event items that included a set of defined events excluding the defined event of the plurality of defined events as event items of the respective sequence of event items.

11. The computer readable storage device of claim 8, wherein a credit weight for a defined event of the plurality of defined events is proportional to a probability of conversion for a set of defined events of the plurality of defined events that exclude the defined event.

12. The computer readable storage device of claim 8, wherein the determined credit weight for a defined event of the plurality of defined events is proportional to a function of:
a first number of sequences of event items that converted and that included a set of defined events excluding the defined event of the plurality of defined events as event items of the respective sequence of event items; and
a second number of sequences of event items that included a set of defined events excluding the defined event of the plurality of defined events as event items of the respective sequence of event items.

13. The computer readable storage device of claim 8, wherein the plurality of granularity levels form a hierarchy.

14. The computer readable storage device of claim 13, wherein the determined credit weight for each of the plurality of defined events is based on the attribution weights for each of the plurality of defined events defined across the plurality of granularity levels and confidence values for each of the plurality of granularity levels.

15. A system comprising:
one or more processors; and one or more storage devices storing instructions that, when executed by the one or more processors, cause the one or more processors to perform operations comprising:
receiving attribution data from a plurality of client devices responsive to ad tags executing on each of the plurality of client devices;
defining a plurality of events and a conversion, the plurality of defined events defined across a plurality of granularity levels;
determining a plurality of subsets of events for a sequence of event items based on the plurality of defined events, the defined conversion, and attribution data, each of the plurality of subsets of events corresponding to a respective set of event items of the sequence of event items that exclude one of the event items of the sequence of event items;
determining a number of conversions and a number of remaining event items for each of the plurality of subsets of event items;
determining an attribution weight for each of the plurality of defined events defined across the plurality of granularity levels based, at least in part, on a ratio of the determined number of conversions to the determined number of remaining event items for each of the plurality of subset of event items; and
determining a credit weight for each of the plurality of defined events based on the attribution weights.

16. The system of claim 15, wherein the determined credit weight for each of the plurality of defined events is a function of a confidence-weighted average across the plurality of granularity levels.

17. The system of claim 15, wherein the one or more storage devices stores instructions that, when executed by the one or more processors, cause the one or more processors to perform operations further comprising:
determining a first number of sequences of event items that converted and that included a set of defined events excluding the defined event of the plurality of defined events as event items of the respective sequence of event items; and
determining a second number of sequences of event items that included a set of defined events excluding the defined event of the plurality of defined events as event items of the respective sequence of event items.

18. The system of claim 15, wherein the determined credit weight for a defined event of the plurality of defined events is proportional to a probability of conversion for a set of defined events of the plurality of defined events that exclude the defined event.

19. The system of claim 15, wherein the determined credit weight for a defined event of the plurality of defined events is proportional to a function of:
a first number of sequences of event items that converted and that included a set of defined events excluding the defined event of the plurality of defined events as event items of the respective sequence of event items; and
a second number of sequences of event items that included a set of defined events excluding the defined event of the plurality of defined events as event items of the respective sequence of event items.

20. The system of claim 15, wherein the plurality of granularity levels form a hierarchy, and wherein the determined credit weight for each of the plurality of defined events is based on the attribution weights for each of the plurality of defined events defined across the plurality of granularity levels and confidence values for each of the plurality of granularity levels.
